(19) United States
(12) Patent Application Publication
(10) Pub. No.: US 2009/0257553 A1
(43) Pub. Date: Oct. 15, 2009

(54) X-RAY CT APPARATUS AND IMAGE NOISE REDUCTION METHOD

(75) Inventors: Taiga Goto, Tokyo (JP); Koichi Hirokawa, Tokyo (JP)

Correspondence Address: COOPER & DUNHAM, LLP, 30 Rockefeller Plaza, 20th Floor, NEW YORK, NY, 10112, US

(73) Assignee: HITACHI MEDICAL CORPORATION, TOKYO (JP)

(21) Appl. No.: 12/374,161

(22) PCT Filed: Jul. 18, 2007
(86) PCT No.: PCT/JP2007/064166

§ 371 Date: Jan. 16, 2009

(30) Foreign Application Priority Data
Jul. 19, 2006 (JP) 2006-197170

(51) Int. Cl. H05G 1/60

(52) U.S. Cl. 378/19

(57) ABSTRACT

An X-ray CT apparatus that can obtain a tomogram having high spatial resolution without increasing the effect of system noise and dosage is provided. The X-ray CT apparatus has an X-ray source for emitting X-ray, an X-ray detector having plural X-ray detecting elements that detect X-ray transmitted through an examinee as attenuation data and are arranged in a channel direction, a data combining unit for combining attenuation data of plural X-ray detecting elements in the channel direction to obtain composite data, a data decomposing unit for decomposing composite data to obtain respective decomposition data of the plural X-ray detecting elements, and an image re-constructing unit for re-constructing an image of the examinee by using the decomposition data.

### TECHNICAL FIELD

The present invention relates to an X-ray CT apparatus, and particularly to a technique of improving the S/N ratio without reducing spatial resolution of an image.

### BACKGROUND ART

In an X-ray CT apparatus as a medical image diagnosis apparatus for obtaining a tomogram of an examinee by using radiation, a tube voltage and tube current are applied to an X-ray tube on the basis of an imaging condition input by a radiographer. Electrons having the energy corresponding to the applied X-ray tube voltage are discharged from a cathode, and the discharged electrons impinge against a target (anode), whereby X-ray having the energy corresponding to the electron energy is radiated from an X-ray source. X-ray which is attenuated in accordance with a linear attenuation coefficient of a material (examinee) through which the radiated X-ray is transmitted is detected by an X-ray detector disposed so as to face the X-ray source, thereby obtaining attenuation data. The attenuation data concerned are amplified and subjected to A/D conversion and Log conversion to obtain projection data, and the projection data are subjected to image re-construction, whereby a tomography is nondestructively obtained as a distribution diagram of the X-ray attenuation coefficients in the examinee.

The process in which the X-ray transmitted through the examinee is detected by the X-ray detector and the attenuation data are obtained is as follows. That is, the X-ray detector has a plurality of X-ray detecting elements each of which has a scintillator portion for converting X-ray to an optical signal and a photodiode portion for converting the converted optical signal to an electrical signal. The X-ray incident to the X-ray detector is converted to an optical signal at the scintillator portion of each X-ray detecting element, and the optical signal is converted to an electrical signal (detection signal or called as analog data) in the photodiode. The analog data are amplified in a pre-amplifier, and the amplified analog data are converted to digital data in an A/D converter. The digital data are obtained as attenuation data.

The imaging condition contains the tube voltage, the tube current, the scan speed (so-called revolution speed), the spiral pitch, FOV (Field of view), so-called imaging visual field), etc. The imaging condition is manually input from an input device in a control stick by an operator, and it can be selected from plural options. In general, the imaging condition is determined in accordance with an imaging purpose in consideration of the dose amount of X-ray, the identification capability of a diagnosis target such as a tumor or the like in an image and an imaging time.

When attenuation data are obtained, FOV is set in advance by the radiographer. X-ray is radiated from the X-ray source to channels located in the range corresponding to the set FOV, and attenuation data are obtained at the X-ray detector irradiated with the X-ray. In general, FOV is set to a small value when a sharp image is required to be obtained for the purpose of close examination or the like.

However, when the element interval in the channel direction of the X-ray detector is equal, that is, the data sampling interval is equal, there is an unresolved problem that the spatial resolution is not enhanced even when the FOV size is set to be equal to or smaller than some degree of FOV size.

In order to solve this problem, (Patent Document 1) has proposed an X-ray CT apparatus in which a plurality of X-ray detecting elements of a small element size are arranged at the center portion of the X-ray detector. According to this X-ray CT apparatus, when the FOV size is small, the small element size is directly used to enhance the spatial resolution, however, when the FOV size is large, attenuation data are bundled in the channel direction of the X-ray detector, whereby attenuation data based on the large X-ray detecting element size are collected.

Patent Document 1: JP-A-2005-312912

### DISCLOSURE OF THE INVENTION

### Problem to be Solved by the Invention

However, the Patent Document 1 has the following unsolved problem. That is, In the Patent Document 1, when the FOV size is small, the X-ray detecting elements of the small element size are directly used. However, when the element size is small, the number of photons incident to the X-ray detecting elements is reduced, so that the affect of system noise increases and thus the noise of a finally-obtained image increases. This is because the final image noise is proportional to the noise/signal ratio (=noise/signal) of the attenuation data and thus when the element size is reduced to half, the signal amount is reduced to half, however, the system noise amount hardly varies.

Here, the system noise contains electromagnetic noises from a high voltage generator, a data collector, etc., noise in the pre-amplifier, etc. which are contaminated into analog data before the A/D conversion, that is, the attenuation data detected by the X-ray detector.

The projection data used in the image re-construction in CT are obtained by performing the A/D conversion and the Log conversion on the attenuation data which are detected by the X-ray detector. If there is no system noise, the detected attenuation data is necessarily equal to zero or more even when the attenuation data value is small. However, actually, when the attenuation data value is small, that is, X-ray is greatly attenuated by an examinee, there is a case where the attenuation data is equal to zero or less or near to zero due to the effect of the system noise. The value of the data after the Log conversion diverges (that is, it becomes a very large projection data value). That is, when the imaging dose is little and the attenuation data is small, a very large error occurs because the system noise is added.

As described above, in order to reduce the effect of the system noise under the situation that it is difficult to reduce the system noise, it is desired to increase the signal amount. However, in order to increase the signal amount, it is necessary to increase the number of photons, which cause increase of the dose, that is, the X-ray exposure amount. Preferably, when FOV is set to a small value, it is better that the resolution of the image can be enhanced without increasing the effect of the system noise.

The present invention has been implemented in view of the foregoing situation, and has an object to provide an X-ray CT apparatus that can obtain a tomogram having high spatial resolution without increasing the effect of system noise and dosage.

### Means of Solving the Problem

In order to solve the above problem, the X-ray CT apparatus of the present invention is characterized by comprising: an X-ray source for emitting X-ray; an X-ray detector having a plurality of X-ray detecting elements that detect X-ray transmitted through an examinee as attenuation data and are arranged in a channel direction; a data combining unit for combining attenuation data of the plural X-ray detecting elements in the channel direction to obtain composite data; a data decomposing unit for decomposing the composite data to obtain decomposition data of each of the plural X-ray detecting elements; and an image re-constructing unit for re-constructing an image of the examinee by using the decomposition data.

Furthermore, in order to solve the above problem, an image noise reducing method for an X-ray CT apparatus according to the present invention is characterized by comprising: a combining step of obtaining composite data of attenuation data of plural adjacent X-ray detecting elements; a decomposing step of decomposing the composite data to obtain plural decomposition data; and a step of re-constructing an image of an examinee by using the decomposition data.

### EFFECT OF THE INVENTION

According to the present invention, there can be provided an X-ray CT apparatus that can obtain a tomogram having high spatial resolution without increasing the effect of the system noise and the dosage.

### BRIEF DESCRIPTION OF THE DRAWINGS

FIG. 1 is a diagram showing the outlook of a first embodiment of a medical image diagnosis apparatus (X-ray CT apparatus) to which the present invention is applied.

FIG. 2 is a diagram showing the construction of the first embodiment of the medical image diagnosis apparatus.

FIG. 3 is a diagram showing the flow of the processing of the first embodiment of the medical image diagnosis apparatus.

FIG. 4 is a diagram showing a method of combination processing and decomposition processing according to the first embodiment of the medical image diagnosis apparatus.

FIG. 5 is a diagram showing a method of combination processing and decomposition processing according to a second embodiment of a medical image diagnosis apparatus to which the present invention is applied.

FIG. 6 is a diagram showing a method of combination processing and decomposition processing according to a third embodiment of a medical image diagnosis apparatus to which the present invention is applied.

FIG. 7 is a diagram showing a method of combination processing and decomposition processing according to a fourth embodiment of a medical image diagnosis apparatus to which the present invention is applied.

FIG. 8 is a diagram showing a method of combination processing and decomposition processing according to a fifth embodiment of a medical image diagnosis apparatus to which the present invention is applied.

FIG. 9 is a diagram showing a method of combination processing and decomposition processing according to a sixth embodiment of a medical image diagnosis apparatus to which the present invention is applied.

### DESCRIPTION OF REFERENCE NUMERALS

10 X-ray CT apparatus, 12 bed, 14 examinee, 20 scanner, 21 X-ray source, 23 X-ray detector, 40 operating unit

### BEST MODES FOR CARRYING OUT THE INVENTION

Best modes for carrying out the Invention will be described with reference to the accompanying drawings.

### First Embodiment

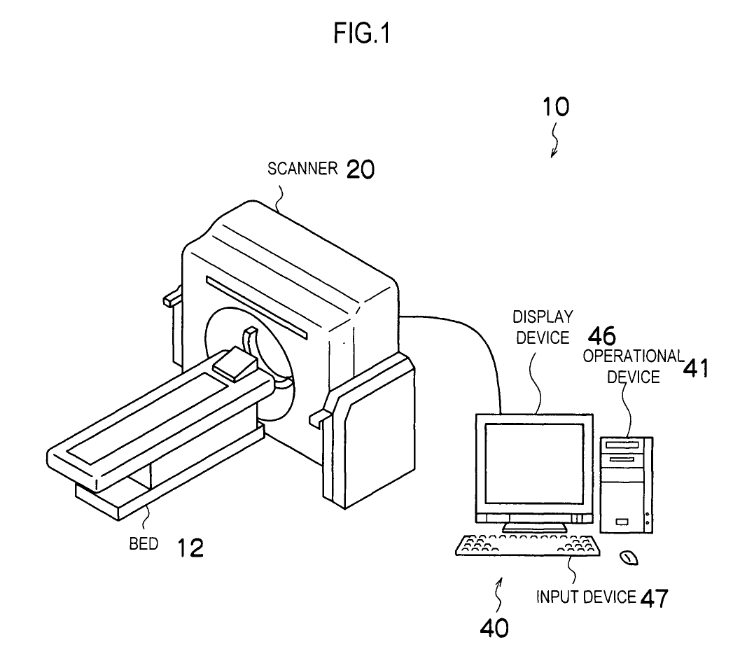

As shown in FIG. 1, an embodiment relates to a medical image diagnosis apparatus 10 in which an examinee 14 placed on a bed 12 is imaged by a scanner 20, a tomogram to be operated and re-constructed in an operational device 41 is displayed on a display device 46.

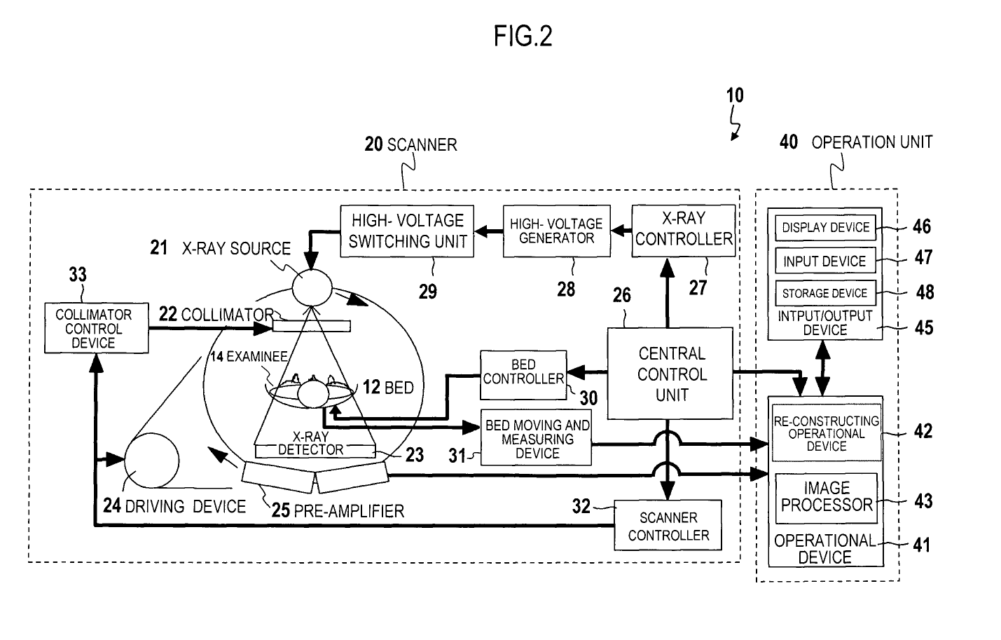

FIG. 2 shows an example in which the present invention is applied to an X-ray CT apparatus as a medical image diagnosis apparatus, and is a diagram showing the construction of an X-ray CT apparatus 10 of the first embodiment according to the present invention. The X-ray CT apparatus 10 comprises the bed 12 which is moved while the examinee 14 is placed on the bed 12, the scanner 20 for picking up an image of the examinee 14 and the operating unit 40 for inputting an imaging condition and re-constructing and displaying tomograms. The X-ray CT apparatus 10 is an example of a rotate-rotate type (third generation). An X-ray source 21 for emitting X-ray in the form of a fan and an X-ray detector 23 having plural (for example, 1000 or more) X-ray detecting elements facing the X-ray source 21 are disposed on a rotational disc rotating around a predetermined rotational center, and the rotational disc is rotated to collect attenuation data of X-ray. However, the present invention is not limited to this rotate-rotate type, and it is applicable to other types.

The scanner 20 mainly comprises an X-ray source 21 for emitting X-ray, a high-voltage generator 28 for applying a voltage to the X-ray source 21, an X-ray controller 27 for controlling generation of X-ray, an X-ray detector 23 for detecting X-ray transmitted through the examinee and a scanner controller 32 for controlling the operation of the scanner.

The operating unit 40 mainly comprises an operational device 41 and an input/output device 45. The operation device 41 mainly comprises a re-constructing operational device 42 to which attenuation data detected by the X-ray detector are input and which processes the input attenuation data to re-construct a tomogram, and an image processor 43 for processing the re-constructed tomogram. The input/output device 45 comprises a display device 46 for displaying the re-constructed tomogram, an input device 47 through which an imaging condition, etc. are input by the operator, and a storage device 48 for storing the re-constructed tomogram.

When the operator inputs an imaging condition (tube current, tube voltage, revolution speed, spiral pitch, etc.) and a re-constructing condition (image FOV, re-constructing filter, image slice thickness, re-constructing slice position, etc.) to the input device 47, on the basis of the instruction thereof, a central control unit 26 transmits control signals necessary for imaging to the X-ray controller 27, the bed controller 30 and the scanner controller 32, and receives an imaging start signal to start an imaging operation. When the imaging operation is started, a control signal is transmitted from the X-ray controller 27 to the high-voltage generator 28, and a high voltage is applied from the high-voltage generator 28 through a high voltage switching unit 29 to the X-ray source 21, whereby X-ray is emitted from the X-ray source 21 and applied to the examinee 14. At the same time, a control signal is transmitted from the scanner controller 32 to the driving device 24, and the X-ray source 21, a collimator 22, the X-ray detector 23 and the pre-amplifier 25 are rotated around the examinee 14 by the driving device 24. Furthermore, the bed 12 on which the examinee 14 is placed is kept stationary in a circular scan operation and translated in parallel in the rotational axis direction of the X-ray source 21, etc. in a spiral scan operation by the bed controller 30 and a bed moving measuring device 31. The irradiation area of the irradiated X-ray is limited by the collimator 22 which is controlled by a collimator controller 33, absorbed (attenuated) by each tissue in the examinee 14, passed through the examinee 14 and then detected by the X-ray detector 23.

The X-ray detected by the X-ray detector 23 is converted to an electrical signal, and input as projection data to the operational device 41. The projection data input to the operational device 41 is subjected to image re-constructing processing in the re-constructing operational device 42 of the operational device 41. The re-constructed image is stored in the storage device 48 of the input/output device 45, and displayed as a CT image on the display device 46. Alternatively, the re-constructed image is processed in the image processor 43, and then displayed as a CT image on the display device 46.

Next, a method of converting the X-ray detected in the X-ray detector 23 to the projection data will be described.

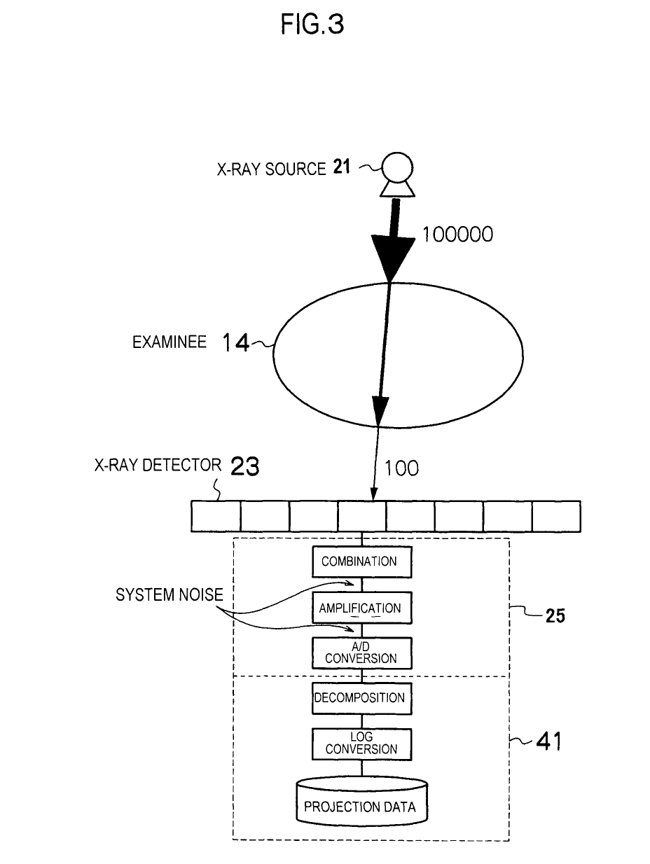

As shown in FIG. 3, the X-ray irradiated from the X-ray source 21 is transmitted through the examinee 14, and then incident to each X-ray detecting element of the X-ray detector 23. The incident X-ray is converted to light at the scintillator portion every X-ray detecting element, and the light is converted to an electrical signal at the photodiode portion. The electrical signal is input to the data collecting device (DAS: not shown) in the pre-amplifier 25, and the electrical signals from the plural X-ray detecting elements are combined with one another and collected as composite data. The composite data are amplified by the pre-amplifier 25, and digitalized in the A/D converter. The composite data digitalized in the A/D converter are decomposed to data of each X-ray detecting element, and each decomposition data is subjected to Log conversion, thereby obtaining the projection data.

Next, a method of combining the data of the X-ray detecting elements (combination processing) and a method of decomposing composite data (decomposition processing) will be described. The combination processing is executed by DAS in the pre-amplifier 25, and the decomposition processing is executed by the operational device 41. This is also applicable to the other embodiments described below.

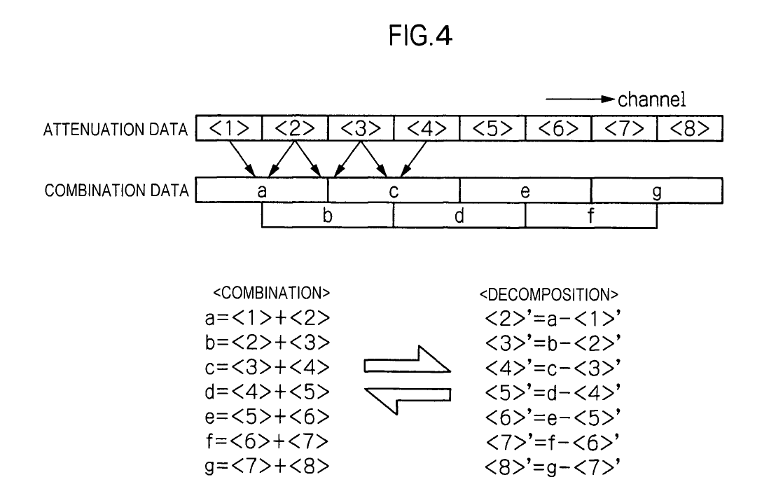

As shown in FIG. 4, attenuation data <1> to <8> of the X-ray detecting elements arranged at an equal interval (hereinafter referred to as equally-arranged) in the channel direction (round direction) of the X-ray detector are combined with one another to obtain composite data a to g. In FIG. 4, the description is made on a case where eight X-ray detecting elements is provided. However, the number of the X-ray detecting elements is not limited to eight, but it may be equal to nine or more or to seven or less.

In the combination processing, DAS adds the attenuation data <1> of the X-ray detecting element disposed at the left end of the X-ray detector and the attenuation data <2> of the X-ray detecting element adjacent to the X-ray detecting element at the left end to obtain the composite data a. Likewise, the attenuation data <2> and the attenuation data <3> are added to obtain the composite data b. By repeating this processing, the composite data a to g are obtained. That is, the attenuation data of the adjacent two X-ray detecting elements are added to each other to obtain one composite data.

In the decomposition processing, the operational device 41 subtracts the decomposition data <1>′ from the composite data a to obtain decomposition data <2>′. Likewise, the decomposition data <2>′ is subtracted from the composite data b to obtain decomposition data <3>′. By repeating this processing, the decomposition data <1>′ to <8>′ are obtained. That is, the decomposition data of one of two X-ray detecting elements used to combine composite data is subtracted from the composite data concerned to obtain the decomposition data of the other X-ray detecting element. In general, decomposition data of at least one X-ray detecting element out of the plural X-ray detecting elements corresponding to the plural attenuation data used to combine composite data is obtained from the composite data concerned.

The decomposition data <1>′ is calculated as follows.

### <Method 1>

When the data <1>, <2> at the end portion of the X-ray detector do not contain any attenuation of X-ray which is caused by the examinee, that is, when the examinee does not located on the transmission passage of the X-ray (this condition is satisfied in the normal imaging operation), the attenuation data <1> and the attenuation data <2> can be obtained by dividing the composite data a by 2 because the attenuation data <1> and the attenuation data <2> are equal to each other. That is, <1>′=<2>′=a/2.

### <Method 2>

The attenuation data <1> is air data which does not contain any attenuation of X-ray, that is, air data when the examinee is not located on the transmission passage of X-ray, and thus the attenuation data <1> which is subjected to reference correction is equal to 1. That is, the composite data a is a value obtained by adding the attenuation data <2> with 1. That is, <1>′ is set to 1, <2>′ is set to a−1.

In the foregoing description, the decomposition processing is executed before the Log conversion. The decomposition may be executed after the Log conversion because the decomposition processing is executed after the A/D conversion. In this case, if the <method 2> is used, the value obtained by subjecting the attenuation data <1> to the Log conversion is equal to 0 (Log 1=0), and thus the composite data a is equal to the attenuation data <2>.

As described above, according to this embodiment, the signal amount can be increased by combining the attenuation data of the X-ray detecting elements, and thus the effect of the system noise on the signal value can be reduced to thereby enhance the S/N ratio. Furthermore, the S/n ratio can be enhanced without increasing the X-ray dose applied to the examinee, that is, with keeping the X-ray exposure amount little. Furthermore, the composite data are decomposed into the attenuation data of the respective X-ray detecting elements, whereby high spatial resolution can be kept in the reconstructed image.

### Second Embodiment

Next, a second embodiment of the present invention will be described. In the X-ray CT apparatus of the first embodiment, the attenuation data of all the X-ray detecting elements disposed in the X-ray detector are subjected to the combination processing, however, the present invention is not limited to this style.

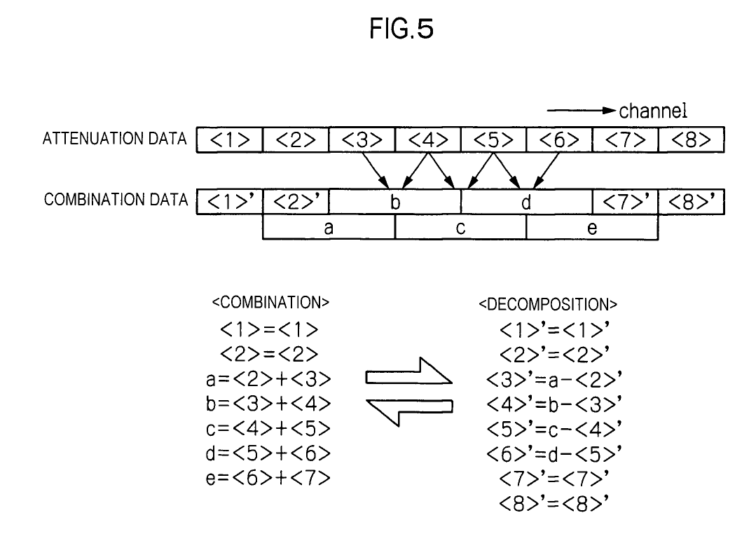

In the X-ray CT apparatus of this embodiment, attenuation data of X-ray detecting elements disposed around the center portion of the X-ray detector at which X-ray is greatly attenuated by the examinee, that is, attenuation data from X-ray detecting elements on which the effect of the system noise is great are subjected to the combination processing and the decomposition processing. FIG. 5 is a diagram showing the method of the combination processing and the method of the decomposition processing in the X-ray CT apparatus of this embodiment. In FIG. 5, the same parts as the first embodiment are represented by the same reference numerals, and the description thereof is omitted.

An imaging target such as a human body or the like is near to a cylindrical body, and the attenuation data is more greatly attenuated at the center portion of the X-ray detector than that at the end portion of the X-ray detector. In other words, the number of photons is more liable to decrease at the center portion of the detector. Therefore, the effect of the system noise appears more strongly at the center portion of the X-ray detector due to the decrease of the signal level. Conversely, the effect of the system noise is more greatly lowered at the end portion of the X-ray detector than that at the center portion. Therefore, according to this embodiment, the attenuation data from the elements at the center portion of the X-ray detector at which the effect of the system noise is greater are subjected to the combination processing and the decomposition processing.

Next, the method of the combination processing and the decomposition processing will be described.

The attenuation data <1>, <2>, <7>, <8> of the X-ray detecting elements located at the end portions of the X-ray detector are not combined with one another, and the combination is started from the attenuation data <3> of the X-ray detecting element located at the center portion of the X-ray detector. That is, the attenuation data from the X-ray detecting elements at the center portion side in the channel direction of the X-ray detector are combined with one another.

Specifically, in the combination processing, DAS adds the attenuation data <2> of the X-ray detecting element disposed at the left end of the X-ray detecting elements to be subjected to the combination processing with the attenuation data <3> of the X-ray detecting element adjacent to the X-ray detecting element disposed at the left end of the X-ray detecting elements to be subjected to the combination processing, thereby obtaining the composite data a. Likewise, the attenuation data <3> and the attenuation data <4> are added to each other to obtain the composite data b. By repeating this operation, the composite data a to e are obtained.

In the decomposition processing, the operational device subtracts the decomposition data <2>′ from the composite data a to obtain the decomposition data <3>′. Likewise, the decomposition data <3>′ is subtracted from the composite data b to obtain the decomposition data <4>′. By repeating this operation, the decomposition data <3>′ to <6>′ are obtained. Here, the decomposition data <1>′, <2>′, <7>′, <8>′ are obtained by amplifying the non-combined attenuation data <1>, <2>, <7>, <8> in the pre-amplifier and digitalizing them in the A/D converter. That is, the attenuation data of the X-ray detecting elements located at the end portions in the channel direction of the X-ray detector are directly used as the decomposition data of the X-ray detecting elements concerned.

As described above, according to this embodiment, the effect of the system noise can be reduced without deterioration of the spatial resolution. Furthermore, the processing cost and the apparatus cost can be reduced by reducing the application range on which the combination/decomposition processing is executed.

### Third Embodiment

Next, a third embodiment of the present invention will be described. In the X-ray CT apparatus of the first embodiment described above, the X-ray detector in which all the arranged X-ray detecting elements are equal to one another in size is used. However, the present invention is not limited to this style.

In the X-ray CT apparatus of this embodiment, when FOV is small, the size of the X-ray detecting elements at the center portion of the X-ray detector is set to be smaller than the size of the X-ray detecting elements at the end portions of the X-ray detector to avoid deterioration of the spatial resolution, and the X-ray detecting elements are arranged in a high dense state at the center portion of the X-ray detector. However, X-ray incident to the center portion of the X-ray detector is greatly attenuated by the examinee, and the attenuated X-ray is incident to the small X-ray detecting elements. Therefore, the attenuation data output from the X-ray detecting elements are small values, and also the effect of the system noise is increased. Therefore, the X-ray CT apparatus of this embodiment executes the combination processing and the decomposition processing on the attenuation data from the X-ray detecting elements of small size at the center portion.

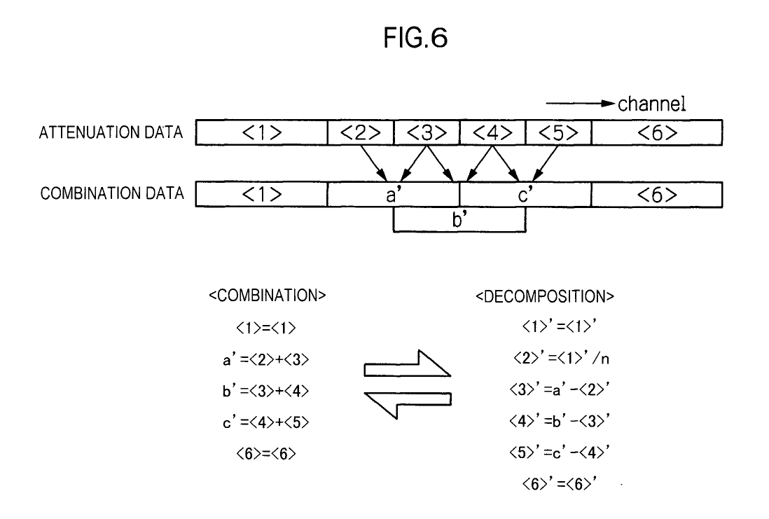

FIG. 6 is a diagram showing a method of the combination processing and the decomposition processing in the X-ray CT apparatus of this embodiment. In FIG. 6, the same parts as the first embodiment are represented by the same reference numerals, and the description thereof is omitted.

The X-ray detector shown in FIG. 6 is an example in which the X-ray detecting elements are disposed in an uneven arrangement in which the size thereof is varied in accordance with the channel. The size of the X-ray detecting elements at the center portion in the channel direction of the X-ray detector is smaller than the size of the X-ray detecting elements at the end portions in the channel direction of the X-ray detector, and it is equal to 1/n (n represents a real number larger than 1). In this case, the combination processing and the decomposition processing are applied to a portion at which the size of the X-ray detecting element is small, that is, a portion at which the effect of the system noise is large.

Next, the method of the combination processing and the decomposition processing will be described.

In the combination processing, DAS keeps the attenuation data <1> and <6> of the large X-ray detecting elements unvaried and starts the combination processing from the attenuation data <2> of the small X-ray detecting element. The attenuation data <2> and the attenuation data <3> are added to each other to obtain composite data a′. Likewise, the attenuation data <3> and the attenuation data <4> are added to each other to obtain composite data b′. By repeating this operation, the composite data a′ to c′ are obtained.

In the decomposition processing, the operational device 41 subtracts the decomposition data <2>′ from the composite data a′ to obtain decomposition data <3>′. Likewise, the decomposition data <3>′ is subtracted from the composite data b′ to obtain decomposition data <4>′. By repeating this operation, the decomposition data <3>′ to <5>′ are obtained. Here, the decomposition data <1>′, <6>′ are obtained by amplifying the non-combined attenuation data <1>, <6> in the pre-amplifier and digitalizing them in the A/D converter, and the decomposition data <2>′ is obtained by dividing the decomposition data <1>′ by n.

As described above, according to this embodiment, when FOV is small, the effect of the system noise can be reduced without deteriorating the spatial resolution. Furthermore, the application range on which the combination/decomposition processing is executed is reduced, whereby the processing cost and the apparatus cost can be reduced.

### Fourth Embodiment

Next, a fourth embodiment of the present invention will be described. In the X-ray CT apparatus according to the first embodiment, the combination/decomposition processing is executed on all the X-ray detecting elements disposed in the X-ray detector by the same method. However, the combination method and the decomposition method are not limited to this style.

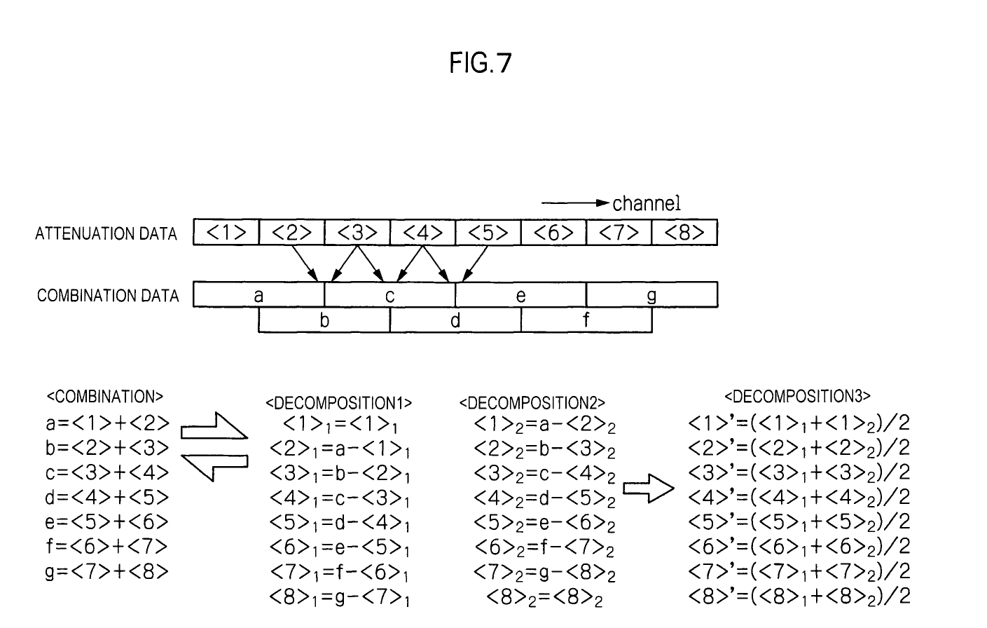

The X-ray CT apparatus of this embodiment decomposes the composite data by using plural methods, and the decomposition data are obtained by using the decomposition data which are obtained by the respective methods. FIG. 7 is a diagram showing the method of the combination processing and the decomposition processing in the X-ray CT apparatus of this embodiment. In FIG. 7, the same parts as the first embodiment are represented by the same reference numerals, and the description thereof is omitted.

The combination processing may be the same as the first embodiment, and thus the detailed description is omitted.

In the decomposition processing, the operational device decomposes composite data by using two methods. According to one method, decomposition data <1>₁ to <8>₁ are obtained on the basis of the attenuation data <1> of the X-ray detecting element disposed at one end of the X-ray detector. According to the other method, decomposition data <1>₂ to <8>₂ are obtained on the basis of the attenuation data <8> of the X-ray detecting element disposed at the other end of the X-ray detector. Final decomposition data <1>′ to <8>′ are calculated by using the decomposition data obtained according to these two methods. There is a case where an error occurs in the decomposition data due to the effect of the system noise, the reading timing or the like and the decomposition data have different values between the case where the attenuation data <1> is used as a reference and the case where the attenuation data <8> is used as a reference. In such a case, the decomposition data <1>₁ to <8>₁ and the decomposition data <1>₂ to <8>₂ are subjected to the summing and averaging processing, whereby the error can be reduced.

First, a method of obtaining the decomposition data <1>₁ to <8>₁ on the basis of the decomposition data <1>₁ will be described.

First, the operational device 41 obtains the decomposition data <1>₁ according to the <method 1> or the <method 2> explained in the aforementioned first embodiment. The decomposition data <1>₁ is subtracted from the composite data a to obtain the decomposition data <2>₁. Likewise, the decomposition data <2>₁ is subtracted from the composite data b to obtain the decomposition data <3>₁. By repeating this operation, the decomposition data <1>₁ to <8>₁ are obtained.

Next, a method of obtaining the decomposition data <1>₂ to <8>₂ on the basis of the decomposition data <8>₂ will be described.

First, the <method 1> or the <method 2> described with respect to the first embodiment is applied to the end portion at the <8> side to obtain the decomposition data <8>₂ in the operational device 41. Subsequently, the decomposition data <8>₂ is subtracted from the composite data g to obtain the decomposition data <7>₂. Likewise, the decomposition data <7>₂ is subtracted from the composite data f to obtain the decomposition data <6>₂. By repeating this operation, the decomposition data <1>₂ to <8>₂ are obtained.

Next, a method of obtaining the decomposition data <1>′ to <8>′ on the basis of the decomposition data <1>₁ to <8>₁ and the decomposition data <1>₂ to <8>₂ will be described.

The operational device 41 executes the summing and averaging processing on the decomposition data <1>₁ and the decomposition data <1>₂ to obtain <1>′. Likewise, the decomposition data <2>₁ and the decomposition data <2>₂ are subjected to the summing and averaging processing to obtain <2>′. By repeating this operation, the decomposition data <1>′ to <8>′ are obtained.

In this embodiment, the decomposition data are obtained on the basis of the attenuation data of the X-ray detecting elements disposed at the end of the X-ray detector. However, the decomposition start point may be set to some midpoint in the arrangement of the detector. In this case, much data are obtained from <1>₁, <1>₂, <1>₃, etc., and thus median processing or weighted summing processing may be executed.

As described above, according to this embodiment, the effect of the system noise can be reduced without deteriorating the spatial resolution. Furthermore, the results obtained by the plural decomposing methods are averaged to obtain the final decomposition data, so that the error of the decomposition can be reduced.

### Fifth Embodiment

Next, a fifth embodiment according to the present invention will be described. In the X-ray CT apparatus of the first embodiment, the combination and decomposition are executed on all the X-ray detecting elements disposed in the X-ray detector. However, the combination method and the decomposition method are not limited to this style.

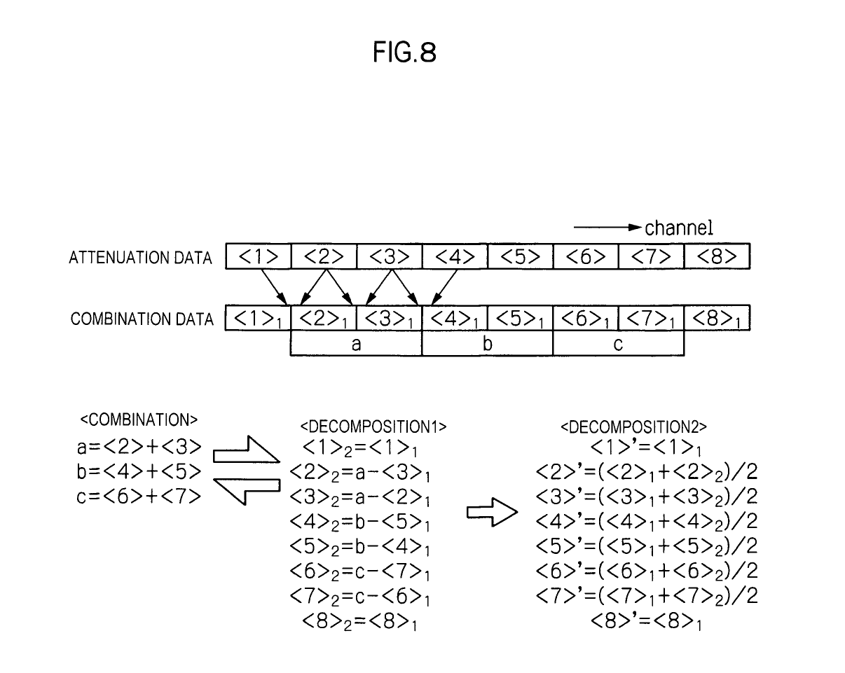

In the X-ray CT apparatus of this embodiment, the composite data and the attenuation data which is not subjected to the combination/decomposition processing like the prior art are combined with each other to obtain the final decomposition data. FIG. 8 is a diagram showing the method of the combination processing and the decomposition processing in the X-ray CT apparatus of this embodiment. In FIG. 8, the same parts as the first embodiment are represented by the same reference numerals, and the description thereof is omitted.

In the decomposition processing, the operational device 41 calculates the final decomposition data <1>′ to <8>′ from the decomposition data <1>₁ to <8>₁ obtained by amplifying and A/D-converting the attenuation data <1> to <8> according to the conventional method and the decomposition data <1>₂ to <8>₂ calculated from the composite data by using the decomposition data <1>₁ to <8>₁. There is a case where an error occurs in the decomposition data due to the effect of the system noise, the reading timing or the like and thus the decomposition data have different values between the decomposition data <1>₁ to obtained from the attenuation data <1> to <8> according to the conventional method and the decomposition data <1>₂ to obtained from the composite data. In such a case, the decomposition data <1>₁ to <8>₁ and the decomposition data <1>₂ to <8>₂ are subjected to summing and averaging, whereby the error can be reduced.

The combination processing to obtain the composite data a to c will be described.

In the composite processing, DAS adds the attenuation data <2> and the attenuation data <3> to obtain the composite data a. Likewise, the attenuation data <4> and the attenuation data <5> are added to obtain the composite data b. By repeating this operation, the composite data a to c are obtained.

Next, the decomposition processing will be described.

In the decomposition processing, the operational device 41 first calculates the decomposition data <1>₂ to <8>₂ from the composite data a to c as follows. The decomposition data is subtracted from the composite data a to obtain the decomposition data <3>₂. Likewise, the decomposition data is subtracted from the composite data a to obtain the decomposition data <2>₂. By repeating this operation, the decomposition data <2>₂ to <7>₂ are obtained. Here, the decomposition data <1>₁ to <8>₁ are data obtained by amplifying and A/D-converting the attenuation data <1> to <8> according to the conventional method, and the decomposition data <1>₂, are identical to the decomposition data <1>₁, <8>₁.

Next, a method of obtaining the decomposition data <1>′ to <8>′ from the decomposition data <1>₁ to <8>₁ and the decomposition data <1>₂ to <8>₂ will be described.

The operational device 41 sums and averages the decomposition data <1>₁ and the decomposition data <1>₂ to obtain <1>′. Likewise, the decomposition data <2>₁ and the decomposition data <2>₂ are summed and averaged to obtain <2>′. By repeating this operation, the decomposition data <1>′ to <8>′ are obtained.

In this embodiment, the combination processing is executed on the attenuation data <2> to <7>. However, the present invention is not limited to this style, and the combination processing may be successively executed on all the attenuation data from the attenuation data <1>.

As described above, according to this embodiment, the effect of the system noise can be reduced without deteriorating the spatial resolution.

### Sixth Embodiment

Next, a sixth embodiment according to the present invention will be described. In the X-ray CT apparatus of the first embodiment, the X-ray detector having X-ray detecting elements arranged on a line is used. However, the present invention is not limited to this style.

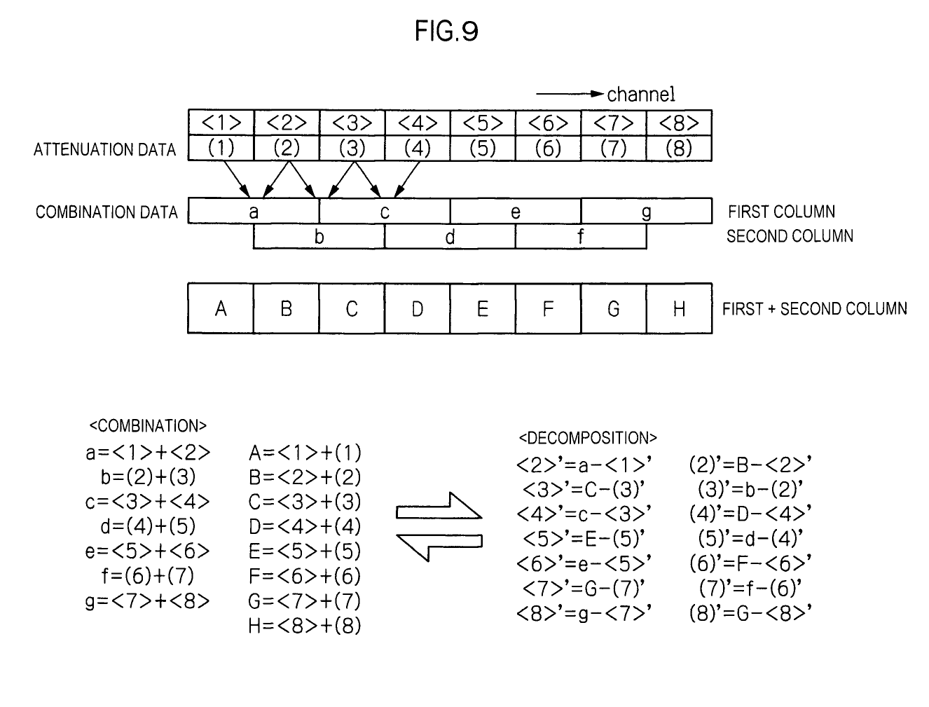

The X-ray CT apparatus of this embodiment executes the combination/decomposition processing containing a column direction by using an X-ray detector in which X-ray detecting elements are also arranged in a direction (column direction) perpendicular to the channel direction. FIG. 9 is a diagram showing a method of the combination processing and the decomposition processing in the X-ray CT apparatus of this embodiment. In FIG. 9, the same parts as the first embodiment are represented by the same reference numerals, and the description thereof is omitted.

An embodiment will be described in the case of two-column arrangement.

First, the combination processing will be described. Here, <1> to <8> represent attenuation data of a first column, and (1) to (8) represent attenuation data of a second column.

First, the combination in the channel direction is executed by the method described below.

DAS adds the attenuation data <1> and the attenuation data <2> to obtain the composite data a. Likewise, the attenuation data (2) and the attenuation data (3) of the X-ray detecting element adjacent to the attenuation data (2) in the channel direction are added to each other to obtain the composite data b. By repeating this operation, the composite data a to g are obtained.

Next, the combination in the column direction is executed according to the following method.

DAS adds the attenuation data <1> and the attenuation data (1) to obtain composite data A. The attenuation data <2> and the attenuation data (2) are added to obtain composite data B. By repeating this operation, the composite data A to G are obtained.

Next, the decomposition processing will be described.

The attenuation data <1>′, (1)′ are data obtained by the X-ray detecting elements disposed at the end of the X-ray detector, and thus the values thereof are equal to each other. Therefore, the operational device 41 sets the attenuation data <1>′, (1)′ to the half value of the composite data A.

Subsequently, the operational device 41 subtracts the calculated attenuation data <1>′ from the composite data a to obtain the attenuation data <2>′. The attenuation data <2>′ is subtracted from the composite data B to obtain the attenuation data (2)′. By repeating this operation, the attenuation data <1>′ to <8>′, (1)′ to (8)′ are obtained.

In this embodiment, the combination processing is executed on the two-column X-ray detector, however, this embodiment is applicable to an X-ray detector of three or more columns by the same method.

As described above, according to this embodiment, the effect of the system noise can be also reduced without deteriorating the spatial resolution in the X-ray CT apparatus having a multiple-column X-ray detector.

The respective embodiments of the present invention have been described above. However, the present invention is not limited to the above embodiments, and various modifications may be made.

For example, in the respective embodiments described above, the X-ray CT apparatus is used. However, the present invention is not limited to this style, and the present invention may be applied to a medical image diagnosis apparatus such as a CT apparatus using neutron radiation, positrons, radiation such as gamma ray or the like, or light, an X-ray imaging apparatus, etc., a medical image diagnosis apparatus using no radiation such as an MRI apparatus, an ultrasonic diagnosis apparatus or the like, and an industrial CT apparatus.

Furthermore, in the respective embodiments described above, the combination and decomposition processing is executed on the attenuation data of the two adjacent X-ray detecting elements. However, the combination and decomposition processing may be executed on the attenuation data of three or more X-ray detecting elements which are sequential in the channel direction or the column direction. For example, when the three attenuation data are combined, the following composite data are obtained with respect to the sequential attenuation data <1> to <5>:

A=<1>+<2>+<3>

B=<2>+<3>+<4>

C=<3>+<4>+<5>

Subsequently, in order to the decomposition data of the respective X-ray detecting elements, the decomposition data <1>′ and <2>′ are obtained according to the <method 1> or the <method 2> described with respect to the first embodiment, and then the decomposition data can be successively obtained as follows:

<3>′=A−(<1>′+<2>′)

<4>′=B−(<2>′+<3>′)

<5>′=C−(<3>′+<4>′)

The same is applied to the combination and decomposition processing in the channel direction for the attenuation data of four or more X-ray detecting elements. Furthermore, the same is applied to the combination and decomposition processing in the column direction in the case of a multiple-column detectors of three or more columns.

Furthermore, in the above embodiments, the X-ray CT apparatus having one set of an X-ray tube and an X-ray detector is used. However, the present invention is applicable to a multiple-tube CT apparatus having plural sets of X-ray tubes and X-ray detectors.

1. An X-ray CT apparatus, characterized by comprising:
an X-ray source for emitting X-ray;
an X-ray detector having a plurality of X-ray detecting elements that detect X-ray transmitted through an examinee as attenuation data and are arranged in a channel direction;
a data combining unit for combining attenuation data of the plural X-ray detecting elements in the channel direction to obtain composite data;
a data decomposing unit for decomposing the composite data to obtain decomposition data of each of the plural X-ray detecting elements; and
an image re-constructing unit for re-constructing an image of the examinee by using the decomposition data.

2. The X-ray CT apparatus according to claim 1, wherein the data decomposing unit obtains, from the composite data, decomposition data of at least one X-ray detecting element corresponding to plural attenuation data used for synthesis of the composite data concerned.

3. The X-ray CT apparatus according to claim 2, wherein by using the decomposition data of a first X-ray detecting element obtained from one composite data, the data decomposing unit obtains decomposition data of a second X-ray detecting element from another composite data.

4. The X-ray CT apparatus according to claim 3, wherein the first X-ray detecting element and the second X-ray detecting element are adjacent to each other.

5. The X-ray CT apparatus according to claim 4, wherein the data decomposing unit obtains decomposition data of every X-ray detecting element from one side in the channel direction of the X-ray detector to the other side thereof.

6. The X-ray CT apparatus according to claim 5, wherein the data decomposing unit sets the decomposition data of an X-ray detecting element at an end portion in the channel direction of the X-ray detector to the half of the composite data obtained by using the attenuation data of the X-ray detecting element concerned.

7. The X-ray CT apparatus according to claim 5, wherein the data decomposing unit sets the decomposition data of an X-ray detecting element at an end portion in the channel direction of the X-ray detector to 1.

8. The X-ray CT apparatus according to claim 5, wherein the data decomposing unit uses the attenuation data of an X-ray detecting element at an end portion in the channel direction of the X-ray detector as the decomposition data of the X-ray detecting element concerned.

9. The X-ray CT apparatus according to claim 4, wherein the size of X-ray detecting elements at the center portion in the channel direction of the X-ray detector is set to 1/n time of the size of X-ray detecting elements at the end portions in the channel direction (n represents a real number larger than 1), and the data decomposing unit sets the decomposition data of a small-size X-ray detecting element adjacent to a large-size X-ray detecting element to 1/n of the decomposition data of the large-size X-ray detecting element concerned.

10. The X-ray CT apparatus according to claim 3, wherein the data decomposing unit sets as the decomposition data a summing and averaging result of respective decomposition data which are obtained by decomposing the composite data according to plural methods.

11. The X-ray CT apparatus according to claim 10, wherein the data decomposing unit sets as the decomposition data a summing and averaging result between first decomposition data obtained on the basis of the attenuation data of the X-ray detecting element at one end portion in the channel direction of the X-ray detector and second decomposition data obtained on the basis of the attenuation data of the X-ray detecting element at the other end portion in the channel direction of the X-ray detector.

12. The X-ray CT apparatus according to claim 3, wherein the data decomposing unit sets a summing and averaging result of the attenuation data and the decomposition data of the X-ray detecting element as new decomposition data of the X-ray detecting element concerned.

13. The X-ray CT apparatus according to claim 3, wherein the X-ray detector has plural X-ray detecting elements which are arranged in the channel direction and in a vertical column direction, the data combining unit obtains composite data of attenuation data of plural X-ray detecting elements in the column direction, and the data decomposing unit subtracts the decomposition data obtained from the composite data in the channel direction of the first column from the composite data in the column direction to obtain decomposition data of the X-ray detecting element on the second column.

14. The X-ray CT apparatus according to claim 1, wherein the data combining unit combines the attenuation data as analog signals in an analog style and has an A/D converter for converting the analog-combined analog signals to digital data, and the data decomposing unit decomposes the composite data converted to the digital data to obtain the decomposition data.

15. The X-ray CT apparatus according to claim 1, wherein the data combining unit superposes attenuation data of one X-ray detecting element on the combination of plural composite data to successively obtain the composite data from one side in the channel direction of the X-ray detector to the other side.

16. The X-ray CT apparatus according to claim 15, wherein the data combining unit adds attenuation data of adjacent two X-ray detecting elements to obtain the composite data, and the data decomposing unit subtracts the decomposition data of one of the two X-ray detecting elements from the composite data to obtain the decomposition data of the other X-ray detecting element.

17. The X-ray CT apparatus according to claim 1, wherein the data combining unit combines attenuation data from an X-ray detecting element at a center portion in the channel direction of the X-ray detector.

18. The X-ray CT apparatus according to claim 1, wherein the size of the X-ray detecting element at the center portion side in the channel direction of the X-ray detector is smaller than the size of the X-ray detecting element at the end portion, and the data combining unit composes attenuation data from a smaller-size X-ray detecting element.

19. An image noise reducing method for an X-ray CT apparatus including an X-ray source for emitting X-ray and an X-ray detector having a plurality of X-ray detecting elements that detect X-ray transmitted through an examinee as attenuation data and are arranged in a channel direction, comprising:
a combining step of combining attenuation data of the plural X-ray detecting elements in the channel direction to obtain composite data;
a decomposing step of decomposing the composite data to obtain decomposition data of each of the plural X-ray detecting elements; and
an image re-constructing step for re-constructing an image of the examinee by using the decomposition data.

20. The image noise reducing method according to the X-ray CT apparatus according to claim 19, wherein the combining step superposes attenuation data of one X-ray detecting element on the combination of plural composite data to successively obtain the composite data from one side in the channel direction of the X-ray detector to the other side, and the decomposing step obtains, from the composite data, decomposition data of at least one X-ray detecting element corresponding to plural attenuation data used for the combination of the composite data.
